(19) United States
(12) Patent Application Publication
(10) Pub. No.: US 2012/0160774 A1
(43) Pub. Date: Jun. 28, 2012

(54) DETERGENT BUILDERS

(75) Inventors: Lucas MOORE, Marietta, GA (US); Deepak PATIL, Friendswood, TX (US); Robert WILSON, Marietta, GA (US)

(73) Assignee: KEMIRA OYJ, Helsinki (FI)

(21) Appl. No.: 12/979,552

(22) Filed: Dec. 28, 2010

(51) Int. Cl. C02F 5/10; C08F 228/02; C08F 220/28; C08F 220/06

(52) U.S. Cl. 210/687; 526/317.1; 526/287; 526/318.42

(57) ABSTRACT

A detergent builder composition includes a (co)polymer of acrylic acid. The acrylic acid copolymers may be selected from a copolymer of acrylic acid and 2-acrylamido-2-methyl propane sulfonic acid, and a copolymer of acrylic acid and hydroxyethyl methacrylate. Also disclosed are processes for removing calcium and/or magnesium ions with the detergent builder composition.

### BACKGROUND OF THE INVENTION

The present invention relates to biodegradable detergent builders. More particularly, the present invention relates to biodegradable detergent builders comprising a (co)polymer of acrylic acid.

Detergent builders are materials that can bind cations (mainly calcium Ca²⁺ and magnesium Mg²⁺) contained in wash solutions, resulting in water softening. Builders improve the quality of the water, hence letting the detergents work in a more efficient way. The builders soften water by removing free water hardness ions by complexation or precipitation. This prevents those particles from reacting with other detergent ingredients, which would cause them to work less efficiently or precipitate from solution (soap scum). They can form insoluble salts that become encrusted in the fabrics and deposit on solid surfaces inside a washing machine. In this way, the builders extend the life of the washing machine.

Typical builders are sodium carbonate, complexation agents, such as EDTA, soap, and zeolites. They function by sequestering or precipitating the problematic ions. One of the most common builders is sodium triphosphate (STPP), which is used on very large scale for this application. Detergents containing phosphorus contribute together with other sources of phosphorus to the eutrophication of many fresh waters, thus having undesired environmental effects.

The chelating agent EDTA (ethylenediamine tetraacetic acid) is a compound of massive use world wide with household and industrial applications, being one of the anthropogenic compounds with highest concentrations in inland European waters. It is a powerful complexing agent of metals and a highly stable molecule, offering a considerable versatility in industrial and household uses. Since it is applied predominantly in aqueous medium, it is released into the environment through wastewaters. Its presence in soils may be due to agrochemical application or disposal of products containing EDTA in garbage reservoirs.

There is an increasing concern about the direct or indirect potential effects of the presence of EDTA in the environment. Numerous field studies have shown that complexation with EDTA may mobilize contaminant metal ions. EDTA may avoid the precipitation of heavy metals in solution or, on the contrary, cause a dissolution effect of heavy metals adsorbed in sediments. Hence, the result is an enhanced mobilization of heavy metals.

Another aspect to be considered is the possible contribution of EDTA in eutrophication water processes. This phenomenon is relevant, since the molecule contains approximately 10% of nitrogen that could eventually be available to the aquatic microbiota. EDTA would also have an indirect effect, when it redissolves the calcic and ferric phosphates, releasing phosphorous and thus contributing to an increase in the productivity of the waters.

EDTA resistance to bacterial biodegradation is widely documented. The compound is harmful to gram negative bacteria, causing the destruction of their outer membrane. Most of the reports indicate that biological treatments are not efficient in the degradation of the chelate. Hinck et al. (Hinck, M. L.; Ferguson, J.; Puhakka, J.; Proceedings of the 5th IAWQ Symposium on Forest Industry Waste Waters, Vacouver-B.C., Canada, 1996) evaluated EDTA biodegradation in a complete study using four types of different sludge, finding a total absence of EDTA degradation.

There is a growing need for developing better builders to replace EDTA, DTPA, NTA, STPP etc. Although phosphates provide excellent performance, these products have been banned from use as builders in laundry detergents.

### BRIEF SUMMARY

In the present invention it was discovered that certain (co)polymeric detergent builders are efficient as chelating agents but also are highly biodegradable. These include polymers of acrylic acid.

The present invention provides the use of (co)polymer of acrylic acid as a detergent builder.

The present invention also provides a detergent composition containing a (co)polymer of acrylic acid as a detergent builder.

In one embodiment the acrylic acid (co)polymer is a copolymer of acrylic acid and 2-acrylamido-2-methyl propane sulfonic acid.

In another embodiment the acrylic acid (co)polymer is a copolymer of acrylic acid and hydroxyethyl methacrylate.

It is an advantage of the present invention that the detergent builders are biodegradable and the use of traditional harmful builders can be avoided.

It is another advantage of the present invention that the detergent builders have high chelating values when compared to e.g. widely used EDTA thus providing more efficient builders.

### DETAILED DESCRIPTION OF THE INVENTION

A builder is basically a chelation compound that can keep calcium and magnesium in solution, i.e., a sequestor. Chelation is the ability of a ligand, in this case dispersant, to coordinate to a single metal ion through two or more ligation sites. Generally speaking, a chelating ligand has much stronger coordination strength than a monodentate ligand, i.e., one ligation site. Polyacrylates and various derivatives thereof have been synthesized and have shown to provide an affinity for calcium and magnesium sequestering, thus providing prevention of calcium and magnesium salts precipitation. During the application of detergents, calcium and/or magnesium salt precipitation is very much undesirable.

The detergent builders of the present invention may be utilized in any suitable detergent application, such as laundry detergents, dish washing detergents, industrial detergent applications, etc.

The detergent builders of the present invention may be used in any suitable detergent composition. The suitable detergents are well known in the art and may include, but are not limited to, anionic detergent, cationic detergent, ethoxylates or non-ionic (zwitterionic) detergents.

In one embodiment, the polymeric detergent builder is a polymer of acrylic acid (100% AA), which has the biodegradability of over 60%.

The “(co)polymer” as used herein refers to homopolymers of acrylic acid alone and to copolymers of acrylic acid and one or more other monomer.

In one embodiment of the present invention, the copolymeric detergent builder is a copolymer of acrylic acid (AA) and 2-acrylamido-2-methyl propane sulfonic acid (AMPS). The average molecular weight of the copolymer of acrylic acid and 2-acrylamido-2-methyl propane sulfonic acid is typically, but is not limited to, in the range of 9000-20000 Daltons. In one embodiment, the ratio of AA/AMPS is about 60/40% (weight).

In one embodiment, the copolymer of acrylic acid and 2-acrylamido-2-methyl propane sulfonic acid, such as Colloid 2640, has a molecular weight of 9000-20000 Daltons, and it is generally in 45-60% solution of polymer in water, pH 3-7, clear to yellow viscous liquid. In one embodiment the copolymer of acrylic acid and 2-acrylamido-2-methyl propane sulfonic acid has a molecular weight of about 18,000 Daltons.

In one embodiment, of the present invention the copolymeric detergent builder is a copolymer of acrylic acid (AA) and hydroxyethyl methacrylate (HEMA). The average molecular weight of the copolymer of acrylic acid and hydroxyethyl methacrylate is generally, but is not limited to, in the range of 6000-14000 Daltons. In one embodiment the ratio of AA/HEMA is about 70/30% (weight).

In one embodiment, the copolymer of acrylic acid and hydroxyethyl methacrylate, such as LM-03-52-12, has an average molecular weight of about 8600 (measured 8577) Daltons, and it is generally in 45-60% solution of polymer in water, pH 3-7, clear to yellow viscous liquid.

Also other suitable monomers may be included to the copolymers of the present invention. These may include, but are not limited to, vinyl sulfonic acid or vinyl sulfonate salts; vinyl phosphoric acid or vinyl phosphonate salts; vinylidene diphosphonic acid or salts thereof; methacrylic acid; vinyl acetate; vinyl alcohol; vinyl chloride; unsaturated mono- or dicarboxylic acids or anhydrides, such as maleic anhydride, maleic acid, fumaric acid, itaconic acid, aconitic acid, mesaconic acid, citraconic acid, crotonic acid, isocrotonic acid, angelic acid, tiglic acid; vinyl chloride; styrene-p-sulfonic acid, or styrene sulfonates salts; allyl sulfonate salts; acrylamido-2-methylpropanesulfonic acid (AMPS); hydroxyphosphonoacetic acid (HPA); hypophosphorus acids such as H₃PO₃, giving units of formula —PO(OH)—; acrylamides, propargyl alcohol having formula HC≡C—CH₂—OH; butyr-1,4-diol, hydroxyethylmethacrylate (HEMA), hydroxyethylacrylate (HEA) and mixtures thereof.

The synthesis of the copolymeric detergent builder of the present invention can be carried out by any suitable polymerization reaction which is well-known in the art.

Said polymerization reaction can be initiated by any suitable means, which results in generation of a suitable free-radical. In the controlled radical polymerization technique, the source of free radicals can be any suitable method of generating free radicals such as thermally induced method, redox initiating method, photochemical initiating method or high energy radiation such as electron beam, X— or gamma ray radiation. The preferred method of generating free radicals is thermally induced method, such as one carried out at 90° C., but depending on the initiator system the temperature can be lower or higher.

In the controlled radical polymerization, typical thermal initiators are azo compounds, peroxides or peroxyesters. The polymerization initiators are not limited to any particular species but may be any of the conventional initiators, inclusive redox initiators, azo initiators and peroxides. Among them, the azo initiators are preferred and, as specific examples thereof, there may be mentioned, among others, azonitrile compounds such as 2,2′-azobis(2-methylpropionitrile) (AIBN), azobisdimethylvaleronitrile and azobisdimethylmethoxyvaleronitrile; azoamidine compounds such as 2,2′-azobis(methylpropionamidine)dihydrochloride (V-50), VA-041, VA-044 and VA-061 (V-50, VA-041, VA-044 and VA-061 are products of Wako Pure Chemical Industries, Ltd.); azoamide compounds such as VA-080, VA-086 and VA-088 (products of Wako Pure Chemical Industries, Ltd.); azoalkyl compounds such as azodi-tert-octane and azoditert-butane; cyanopropylazo-formamide, 4,4′-azobis(cyanovaleric acid), 4,4′-azobis-(cyanopentanoic acid) dimethylazobismethyl propionate, azobishydroxymethyl-propionitrile and the like. Preferred initiators are 2,2′-azobis-(methylpropionamidine)dihydrochloride (V-50), and 4,4′-azobis(cyanopentanoic acid) or 4,4′-azobis(cyanovaleric acid).

One of these radical polymerization initiators for use in the present invention may be used alone, or two or more thereof may be used as a mixture.

The molar ratio of the radical polymerization initiator to the monomer is preferably from 0.0001 to 0.1, more preferably from 0.0005 to 0.05, still more preferably from 0.0005 to 0.01.

### EXAMPLES

The chelation values were measured with the following protocol.

1) Accurately weigh 2.00 g of respective polyacrylate to a 250 ml beaker and add 50 ml of distilled water. Stir until completely dissolved.

2) Adjust the pH of the solution from (1) to 8.0 with 1.0 N NaOH.

3) Pipet 10.0 ml of 2.0% soda ash solution into the beaker from (2).

4) Adjust the pH of the solution in (3) to 11.0 with 0.2 N NaOH and add distilled water to the 150 ml mark on the beaker.

5) Titrate the sample from (4) with a 4.41% calcium acetate monohydrate solution to a distinct, permanent turbidity.

6) Maintain the pH of the solution from (5) at 11.0 with 0.2 N NaOH.

The data below was obtained by observing the amount of calcium that can be sequestered by the ligating polymer prior to precipitation. Without chemical assistance there is very little calcium maintained in solution. EDTA can sequester 55.7 times more calcium than in the absence of any sequestering or chelating agent. Most of the polymers tested are significantly better than EDTA meaning at least 2 times more calcium can be sequestered (Table 1). One embodiment of this invention provides AA/AMPS product that can sequester 40 times more calcium than EDTA and biodegrades 23% after 28 days. AA/HEMA can sequester nearly 13 times more calcium than EDTA and biodegrades 36% after 28 days. The AA/ADP (3-allyloxy-1,2-propandiol) polymer can sequester nearly 12 times more calcium than EDTA (no biodegradation study performed).

TABLE 1

| | Calcium |
|---|---|
| | Sequestering |
| Sample | Relative |
| Ligand Free | 1 |
| EDTA (ethylenediaminetetraacetic acid) | 55.7 |
| AA/AMPS (acrylic acid/acrylamido-2- | 2433.3 |
| methylpropanesulfonic acid copolymer) | |
| AA/HEMA (acrylic acid/acrylamido-2- | 713.3 |
| methylpropanesulfonic acid copolymer) | |
| AA/IM (acrylic acid/imidazole copolymer) | 202.5 |
| Maleic/DEAP (maleic acid/allylphosphonic acid diethyl ester | 164.2 |
| copolymer) | |
| Maleic/ADP | 127.7 |
| AA, RAFT (reversible addition fragmentation transfer | 234.8 |
| polymerized acrylic acid) | |
| AA/ADP (acrylic acid/3-allyloxy-1,2-propandiol copolymer) | 660.7 |
| KN706 (acrylic acid/maleic acid copolymer) | 140.5 |
| AA/AM (acrylic acid/acrylamide copolymer) | 234.4 |
| AA (142) (acrylic acid) | 174.4 |
| SASMAC (maleic acid/anhydride/sodium allyl sulfonate | 99.7 |
| copolymer) | |
| AA (acrylic acid), phosphite term | 201.1 |
| Maleic/Mercaptan (maleic acid/mercaptan copolymer) | 224.9 |
| AA/Mercaptan (acrylic acid/mercaptan copolymer) | 162.2 |

The biodegradation of the copolymers was investigated using a Marine BODIS test. Two copolymers (Table 2) AA/AMPS, also called Colloid 2640, and AA/HEMA, also called LM-03-52-12, had the best chelating ability and biodegradability combination.

TABLE 2

| | Biodegradation | Biodegradation |
|---|---|---|
| Copolymer | Day 14 | Day 28 |
| AA/AMPS | 17% | 23% |
| AA/HEMA | 22% | 36% |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A process for removing calcium and/ magnesium ions from an aqueous solution, the process comprising:
adding a detergent builder to the aqueous solution, wherein the detergent builder is a (co)polymer of an acrylic acid; and
chelating the calcium and/or magnesium ions in the aqueous solution.

2. The process of claim 1, wherein the (co)polymer of the acrylic acid is a copolymer of acrylic acid and 2-acrylamido-2-methyl propane sulfonic acid.

3. The process of claim 2, wherein the (co)polymer of the acrylic acid and 2-acrylamido-2-methyl propane sulfonic acid has an average molecular weight of 9000-20000 Daltons.

4. The process of claim 2, wherein the copolymer of acrylic acid and 2-acrylamido-2-methyl propane sulfonic acid has an average molecular weight of about 18,000 Daltons.

5. The process of claim 1, wherein the (co)polymer of the acrylic acid is a copolymer of acrylic acid and hydroxyethyl methacrylate.

6. The process of claim 5, wherein the copolymer of acrylic acid and hydroxyethyl methacrylate has an average molecular weight of 6000-14000 Daltons.

7. The process of claim 5, wherein the copolymer of acrylic acid and hydroxyethyl methacrylate has an average molecular weight of about 8600 Daltons.

8. A detergent builder composition comprising a (co)polymer of acrylic acid.

9. The detergent builder composition of claim 8, wherein (co)polymer of the acrylic acid is a copolymer of acrylic acid and 2-acrylamido-2-methyl propane sulfonic acid.

10. The detergent builder composition of claim 9, wherein the (co)polymer of the acrylic acid and 2-acrylamido-2-methyl propane sulfonic acid has an average molecular weight of 9000-20000 Daltons.

11. The detergent builder composition of claim 9, wherein the (co)polymer of the acrylic acid and 2-acrylamido-2-methyl propane sulfonic acid has an average molecular weight of about 18000 Daltons.

12. The detergent builder composition of claim 8, wherein the (co)polymer of the acrylic acid is a copolymer of acrylic acid and hydroxyethyl methacrylate.

13. The detergent builder composition of claim 12, wherein the (co)polymer of the acrylic acid and hydroxyethyl methacrylate has a molecular weight of 6000-14000 Daltons.

14. The detergent builder composition of claim 12, wherein the (co)polymer of the acrylic acid and hydroxyethyl methacrylate has a molecular weight of about 8600 Daltons.
